(19) United States
(12) Patent Application Publication
(10) Pub. No.: US 2007/0153336 A1
(43) Pub. Date: Jul. 5, 2007

(54) Scanning device having a floating light source

(75) Inventors: Thomas Sheng, Hsinchu (TW); Yu-Lun Chang, Tou-Feng Town (TW)

Correspondence Address: BIRCH STEWART KOLASCH & BIRCH, PO BOX 747, FALLS CHURCH, VA, 22040-0747, US

(73) Assignee: Avision Inc.

(21) Appl. No.: 11/645,492

(22) Filed: Dec. 27, 2006

(30) Foreign Application Priority Data
Jan. 5, 2006 (TW) 095100413
Jul. 24, 2006 (TW) 095126886

(51) Int. Cl. H04N 1/04

(52) U.S. Cl. 358/474

(57) ABSTRACT

A scanning device includes a housing, a transparent plate, an image acquiring module, a light source module and an elastic member. The transparent plate for supporting an original is mounted on an opening of the housing. The image acquiring module for acquiring an image of the original is movable in a first direction in the housing. The light source module for emitting light to illuminate the original is movable in a second direction perpendicular to the first direction on the image acquiring module. The elastic member for pushing the light source module towards the transparent plate connects the light source module to the image acquiring module. When the transparent plate is not pressed, a distance between the transparent plate and the light source module is kept such that the transparent plate contacts the light source module without losing its degree of freedom when the transparent plate is pressed.

### BACKGROUND OF THE INVENTION

1. Field of Invention

The invention relates to a scanning device having a floating light source, and more particularly to a scanning device, which has a floating light source and the reduced noise, cost, and weight.

2. Related Art

An image acquiring device, such as a scanner, mainly illuminates light on a document, and the reflected light or the transmitted light from the document enters an optical reading device for optical analysis. For example, the scanner usually has a scanning module, which has a light source, such as a cold cathode fluorescent lamp or a linear light source composed of a light-emitting diode and a light-guiding rod. The light source outputs the light to illuminate the reflective original, which reflects the light back to the scanning module so that an image sensor senses an optical signal. Increasing the brightness of the light source can effectively shorten the scanning time but will shorten the lifetime of the light source and consumes a lot of energy.

Because the brightness of the light source at a certain position is inversely proportional to a square of a distance from the position to the light source, the light source is disposed close to a scan window so that the brightness of the light source for illuminating the original can be effectively enhanced. For example, U.S. Pat. Nos. 6,229,636; 6,654,149; and 6,373,613, which are assigned to the assignee of this application, disclose image acquiring devices each having a lamp in sliding contact with a bottom surface of the scan window to perform the scan operation. In these patents, the lamp has to slide on the bottom surface of the scan window, so two ends of the lamp have to be provided with wear-resistant elements having the low friction coefficient and the high-precision. Because the lamp has to slide on the bottom surface of the scan window precisely, the plastic components associated with the installation of each of the scan window and the lamp must have the reduced tolerances caused by the deformations during the manufacturing processes, so that the lamp can be moved smoothly and effectively buffer the deformation of the scan window, which is caused by the self-weight of the original (e.g., a book) placed on the scan window or pressed by the user's force for pressing the original.

In addition, because the lamp has to be kept in contact with the scan window, the uncomfortable noise tends to occur when the lamp slides. Even if the lubricant is applied to the scan window, the noise also cannot be completely eliminated, which cannot satisfy the requirement in the low-noise office.

On the other hand, the scanning module is usually positioned at a home position when no scan operation is performed, and the scanning module at the home position is usually shielded by a housing of the scanner. Because the lamp has to be always kept in contact with the scan window, the transparent plate, such as a glass plate, constituting the scan window has to be large enough to cover the maximum movable range of the scanning module, or otherwise the lamp may have a jitter due to a step between the transparent plate and the housing. Thus, the used transparent plate may increase the cost and the weight of the scanner.

U.S. Pat. No. 6,507,416, and U.S. Pat. No. 6,870,647 which is assigned to the assignee of this application disclose scanning devices each having adjustable lamp brightness, wherein the distance between the lamp and the scan window may be adjusted so that the brightness of the lamp may be adjusted in correspondence with the requirements in various occasions. However, the adjustment of the distance between the lamp and the scan window is not suitable for all occasions, and the adjusting mechanism for adjusting the distance must have the good and precise positioning function, so the cost thereof is high.

### SUMMARY OF THE INVENTION

It is therefore an object of the invention to provide a scanning device, which has a floating light source and has the reduced noise, cost and weight.

To achieve the above-identified object, the invention provides a scanning device including a housing, a transparent plate, an image acquiring module, a light source module and an elastic member. The housing has an opening. The transparent plate is disposed on the opening of the housing. The transparent plate supports an original. The image acquiring module for acquiring an image of the original is disposed in the housing and may be moved in a first direction. The light source module for emitting light to illuminate the original is disposed on the image acquiring module and may be moved in a second direction, which is substantially perpendicular to the first direction. The elastic member for pushing the light source module towards the transparent plate connects the light source module to the image acquiring module. The light source module is positioned at a predetermined distance from the transparent plate such that the transparent plate contacts the light source module when a predetermined force is applied to the transparent plate.

In the above-mentioned scanning device, when the predetermined force is applied to the transparent plate, the transparent plate may contact the light source module and lower the light source module by a predetermined height.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic illustration showing a first state of a scanning device according to a first embodiment of the invention;

FIG. 2 is a schematic illustration showing a second state of the scanning device according to the first embodiment of the invention;

FIG. 3 shows an example of a light source module;

FIG. 4 shows another example of the light source module;

FIG. 5 shows a light source module and an image acquiring module according to a second embodiment of the invention;

FIGS. 6 and 7 are partially schematic illustrations showing a scanning device according to a third embodiment of the invention; and

FIGS. 8 and 9 are partially schematic illustrations showing a scanning device according to a fourth embodiment of the invention.

### DETAILED DESCRIPTION OF THE INVENTION

The present invention will be apparent from the following detailed description, which proceeds with reference to the accompanying drawings, wherein the same references relate to the same elements.

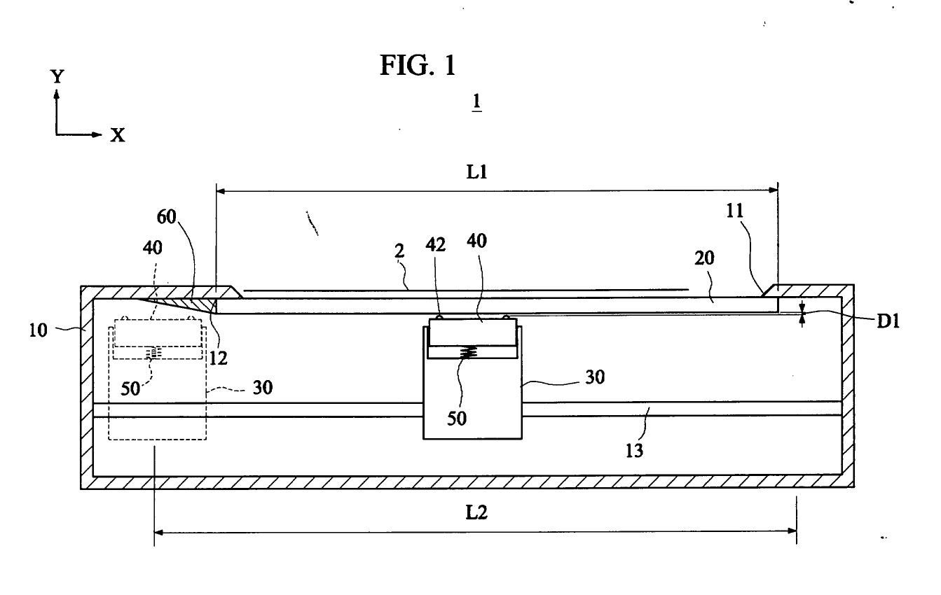

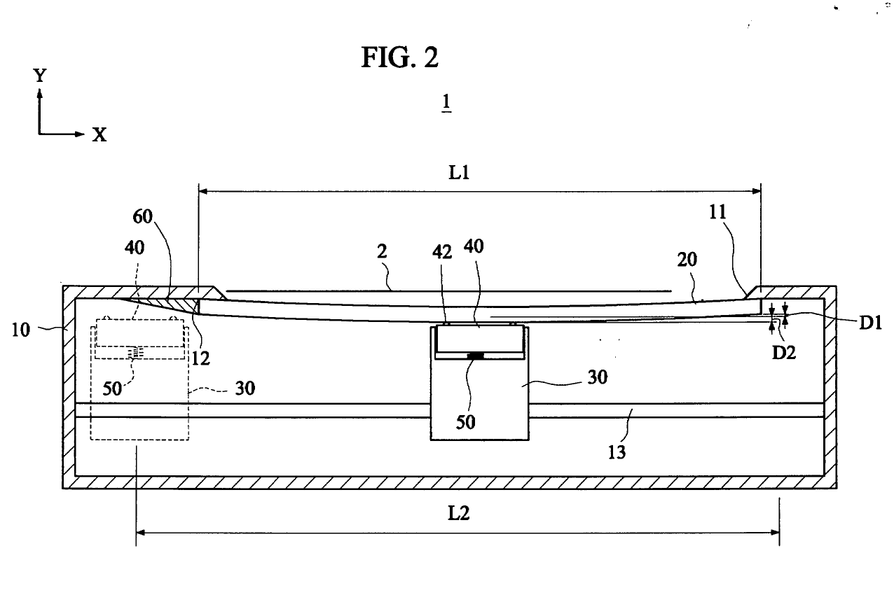

FIGS. 1 and 2 are schematic illustrations showing first and second states of a scanning device 1 according to a first embodiment of the invention. Referring to FIGS. 1 and 2, the scanning device 1 of this embodiment includes a housing 10, a transparent plate 20, an image acquiring module 30, a light source module 40 and an elastic member 50.

The housing 10 has an opening 11. The transparent plate 20 such as a glass plate is disposed on the opening 11 of the housing 10. The transparent plate 20 supports an original 2. The image acquiring module 30 for acquiring an image of the original 2 is disposed in the housing 10 and may be moved along a guiding rod 13 in a first direction (X direction). The light source module 40 has a projection 42 near the transparent plate 20. The light source module 40 for emitting light to illuminate the original 2 is disposed on the image acquiring module 30 and may be moved in a second direction (Y direction). The second direction is perpendicular to the first direction.

The elastic member 50, which may be a compressive spring, a torsional spring or an elastic arm and pushes the light source module 40 towards the transparent plate 20, connects the light source module 40 to the image acquiring module 30. The light source module 40 is positioned at a predetermined distance D1, such as 1 to 2 mm, from the transparent plate 20. Thus, when a predetermined force is applied to the transparent plate 20, the transparent plate 20 may contact the light source module 40. Because the user usually presses the original 2 when the original 2 such as a book is being scanned, the transparent plate 20 tends to deform downwards to contact the light source module 40 due to the resilience of each of the housing 10 and the transparent plate 20. When the predetermined force is increased such that the deformation is enlarged, the transparent plate 20 contacts the light source module 40 and lowers the light source module 40 by a predetermined height D2. The predetermined force may be applied from the human hand to the transparent plate 20 through the original 2, may be applied from the human hand to the transparent plate 20 through the original 2 and the upper cover (not shown), and may also be applied from the deformed housing 10 to the transparent plate 20. In addition, other deformations may be caused by the individual differences due to the tolerances produced when the housing 10 is manufactured.

Thus, when the user does not press the original 2, the transparent plate 20 and the light source module 40 do not contact each other. Further, a length L1 of the transparent plate 20 along the first direction may be shorter than a maximum distance L2 the image acquiring module 30 travels in the first direction. That is, when the image acquiring module 30 and the light source module 40 are in the state indicated by the dashed line, no transparent plate 20 exists above the image acquiring module 30. Thus, the size of the transparent plate 20 can be reduced, and the cost and the weight of the scanning device 1 can be reduced.

In the case of the deformation of the transparent plate 20, in order to prevent the light source module 40 from colliding with the transparent plate 20 or the housing 10 when the light source module 40 moves past an junction 12 of the transparent plate 20 and the housing 10, the scanning device 1 may further include a guiding member 60, which is disposed on the housing 10 and joins the transparent plate 20. The guiding member 60 has an inclined surface for guiding the image acquiring module 30 and the light source module 40 to the transparent plate 20.

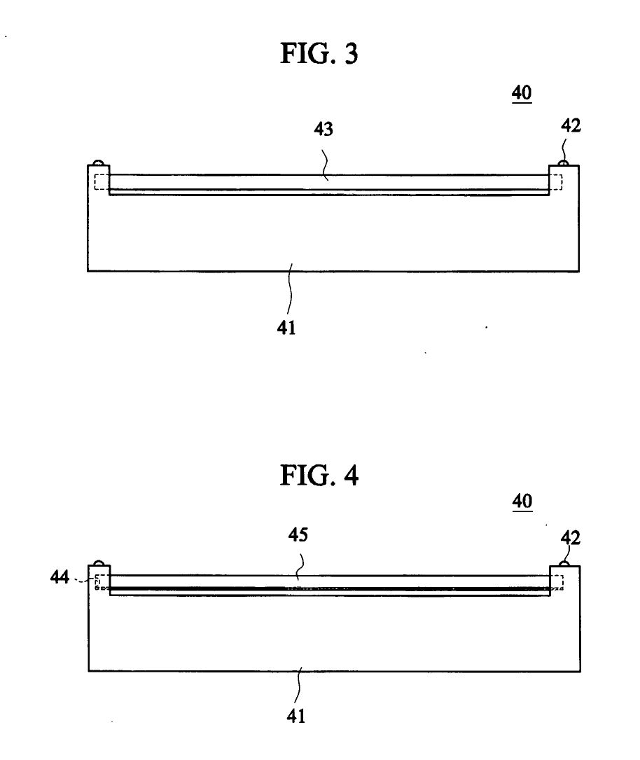

FIG. 3 shows an example of the light source module. Referring to FIG. 3, the light source module 40 includes a base 41 and a light source such as a light tube 43. The base 41 is provided with or integrally formed with projections 42 near the transparent plate 20. The light tube 43 may be a cold cathode fluorescent lamp mounted on the base 41.

FIG. 4 shows another example of the light source module. Referring to FIG. 4, the light source module 40 includes a base 41, a point light source 44 and a light-guiding rod 45. The point light source 44 and the light-guiding rod 45 serve as the light source. The base 41 is provided with or integrally formed with projections 42 near the transparent plate 20. The point light source 44 and the light-guiding rod 45, which generate the light, are mounted on the base 41. The point light source 44 may be a light-emitting diode, which cooperates with the light-guiding rod 45 to generate the linear light source.

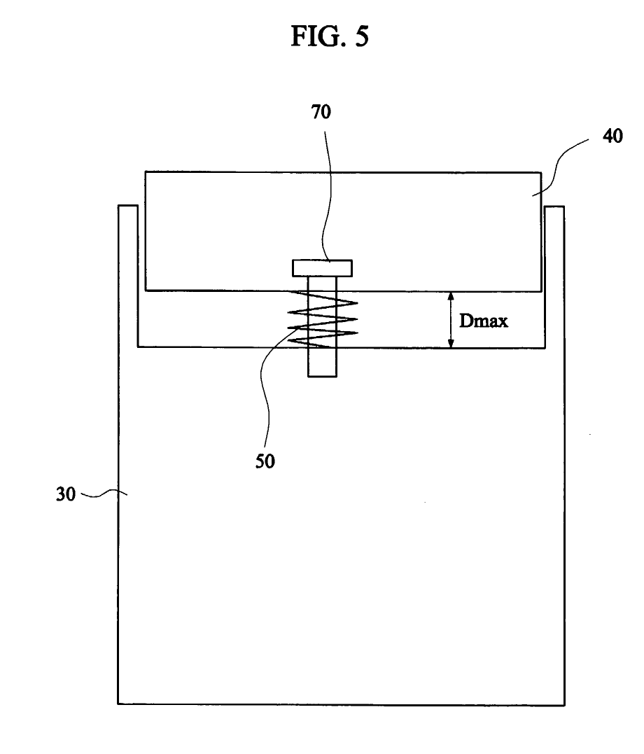

FIG. 5 shows a light source module and an image acquiring module according to a second embodiment of the invention. Referring to FIG. 5, the scanning device 1 of this embodiment further includes a limiting element 70, which connects the light source module 40 to the image acquiring module 30 and limits a distance between the light source module 40 and the image acquiring module 30 to be shorter than a maximum predetermined distance Dmax. The provision of the limiting element 70 is advantageous to the control of the predetermined distance D1 in the state illustrated in FIG. 1, and the limiting element 70 prevents the light source module 40 from being lifted too high while not influencing the pressing down motion of the light source module 40. Thus, the predetermined distance D1 can be maintained even if the manufacturing tolerance of the limiting element 70 is too great. Alternatively, the limiting element 70 is adjustable so that the maximum predetermined distance Dmax may be adjusted. In practice, the limiting element 70 may be a screw, the elastic member 50 may be a compressive spring, and the screw passes through the compressive spring. The maximum predetermined distance Dmax may be adjusted according to the adjusted height of the screw. It is to be noted that the limiting element 70 may also be a hook or a line having a cylinder passing through the compressive spring.

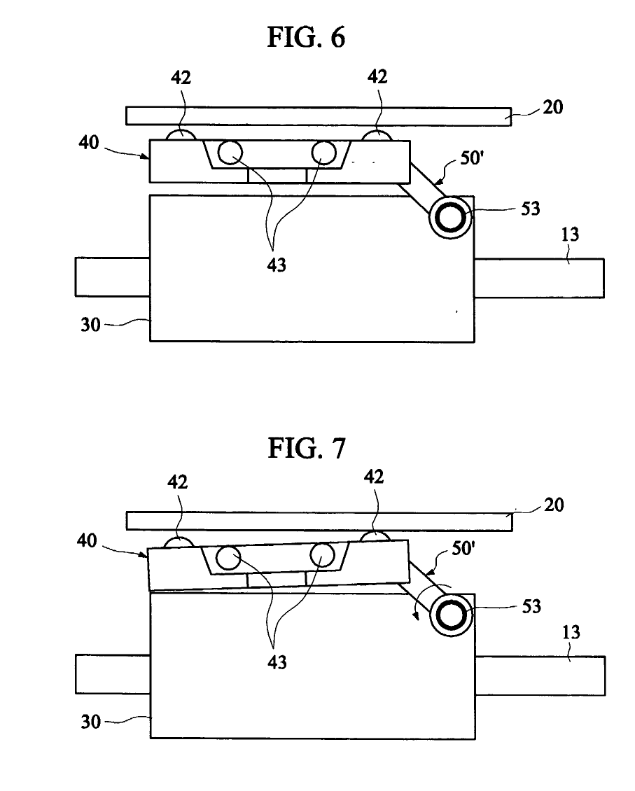

FIGS. 6 and 7 are partially schematic illustrations showing a scanning device according to a third embodiment of the invention. As shown in FIGS. 6 and 7, an elastic member 50′ of the scanning device of this embodiment is an elastic arm having one end fixed to the image acquiring module 30 and the other end fixed to the light source module 40. The one end of the elastic arm 50′ may be rotatably mounted on the image acquiring module 30 through a torsional spring 53. In this embodiment, the light source module 40 includes a base 41 and a lamp 43. The base 41 is formed with one projection 42 or multiple projections 42 near the transparent plate 20. The lamp 43 is mounted on the base 41.

Alternatively, the light source module of this embodiment may also be replaced with the light source module of FIG. 4. In this case, the light source module 40 includes a base 41, a point light source 44 and a light-guiding rod 45. Both of the point light source 44 and the light-guiding rod 45 are mounted on the base 41 and generate the light.

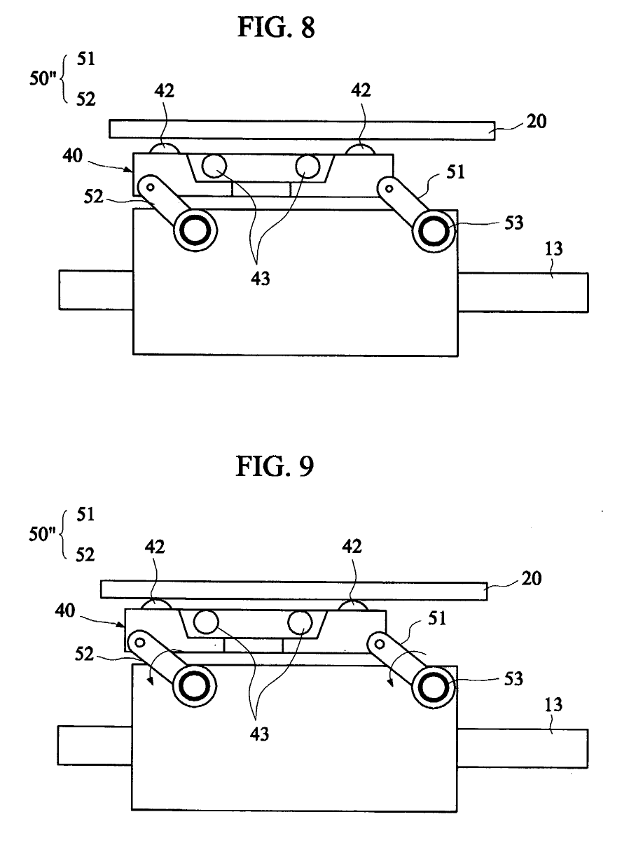

FIGS. 8 and 9 are partially schematic illustrations showing a scanning device according to a fourth embodiment of the invention. Referring to FIGS. 8 and 9, an elastic member 50″ of this embodiment includes a first elastic arm 51 and a second elastic arm 52. One end of each elastic arm 51, 52 is fixed to the image acquiring module 30, and the other end of each elastic arm 51, 52 is fixed to the light source module 40. In this embodiment, the one end of each elastic arm 51, 52 may be rotatably mounted on the image acquiring module 30 through a torsional spring 53, and the image acquiring module 30, the light source module 40, the first elastic arm 51 and the second elastic arm 52 form a parallelogram to constitute a four-bar linkage mechanism so that the light source module 40 can be always held in the horizontal state.

It is appreciated that there may be one or multiple projections 42 in the above-mentioned embodiments, and the projection may be a stationary member, such as a rib, or a movable member, such as a roller or a ball, as long as it protrudes from the surface of the base 41.

According to the above-mentioned structures of the invention, the predetermined distance between the light source module and the transparent plate may be kept when the transparent plate is not pressed. Because the light source module and the transparent plate do not contact each other, no uncomfortable noise will be produced when the light source module is moved, and it is unnecessary to apply the lubrication oil to the transparent plate. In addition, the projection may be integrally formed with the base by way of plastic injection molding, and it is unnecessary to use the conventional wear-resistant sheet with the high precision and the low friction coefficient. Furthermore, the size of the transparent plate may be effectively reduced so that the weight and the cost of the scanning device can be reduced.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A scanning device, comprising:
a housing having an opening;
a transparent plate, mounted on the opening of the housing, supporting an original;
an image acquiring module, disposed in the housing, moving in a first direction and acquiring an image of the original;
a light source module, disposed on the image acquiring module, moving in a second direction substantially perpendicular to the first direction and emitting light to illuminate the original; and
an elastic member, connecting the light source module to the image acquiring module and pushing the light source module towards the transparent plate, wherein the light source module is positioned at a predetermined distance from the transparent plate, so that the transparent plate contacts the light source module when a predetermined force is applied to the transparent plate.

2. The device according to claim 1, wherein when the predetermined force is applied to the transparent plate, the transparent plate contacts the light source module and lowers the light source module by a predetermined height.

3. The device according to claim 2, wherein a length of the transparent plate along the first direction is shorter than a maximum distance the image acquiring module travels in the first direction.

4. The device according to claim 3, further comprising:
a guiding member, disposed on the housing and joining the transparent plate, guiding the image acquiring module and the light source module to the transparent plate.

5. The device according to claim 1, wherein the elastic member is a compressive spring, a torsional spring or an elastic arm.

6. The device according to claim 1, wherein the light source module comprises:
a base, on which a projection is formed near the transparent plate; and
a light source disposed on the base.

7. The device according to claim 6, wherein the projection and the base are integrally formed.

8. The device according to claim 6, wherein the projection is a roller or a ball.

9. The device according to claim 6, wherein the light source comprises a point light source and a light guiding rod.

10. The device according to claim 6, wherein the light source comprises a light tube.

11. The device according to claim 1, further comprising:
a limiting element, connecting the light source module to the image acquiring module, limiting a distance between the light source module and the image acquiring module to be shorter than a maximum predetermined distance.

12. The device according to claim 11, wherein the limiting element is a screw, the elastic member is a compressive spring, and the screw passes through the compressive spring.

13. The device according to claim 11, wherein the limiting element is a cylinder, the elastic member is a compressive spring, and the cylinder passes through the compressive spring.

14. The device according to claim 11, wherein the limiting element is adjustable so that the maximum predetermined distance may be adjusted.

15. The device according to claim 1, wherein the elastic member is an elastic arm, which has one end fixed to the image acquiring module and the other end fixed to the light source module.

16. The device according to claim 15, wherein the one end of the elastic arm is fixed to the image acquiring module through a torsional spring.

17. The device according to claim 1, wherein the elastic member comprises two elastic arms, and each of the elastic arms has one end fixed to the image acquiring module and the other end fixed to the light source module.

18. The device according to claim 17, wherein the one end of each of the elastic arms is fixed to the image acquiring module through a torsional spring, and the image acquiring module, the light source module and the two elastic arms form a parallelogram.
